(19) United States
(12) Patent Application Publication
(10) Pub. No.: US 2026/0358195 A1
(43) Pub. Date: Nov. 12, 2026

(54) METHOD FOR ASCERTAINING THE WEAR STATE, IN PARTICULAR IN ORDER TO PREDICT THE REMAINING SERVICE LIFE AND/OR THE REMAINING OPERATING DURATION, OF AT LEAST ONE RUNNING STRAND OF A DEVICE WHICH USES THE AT LEAST ONE RUNNING STRAND FOR ITS INTENDED USE, DEVICE, AND COMPUTER PROGRAM PRODUCT

(71) Applicants: KV R&D Center GmbH, Contwig (DE); Kiswire Ltd., Busan (KR); Verope AG, Zug (CH)

(72) Inventor: Marco ELIG, Rieschweiler-Mühlbach (DE)

(21) Appl. No.: 19/122,590

(22) PCT Filed: Sep. 27, 2023
(86) PCT No.: PCT/EP2023/076663

§ 371 Date: Apr. 18, 2025

(30) Foreign Application Priority Data
Oct. 19, 2022 (LU) LU502921

(51) Int. Cl. G01M 13/00; B66B 7/12; B66C 15/06

(52) U.S. Cl. CPC G01M 13/00; B66B 7/1215; B66C 15/065

(57) ABSTRACT

The invention relates to a method for ascertaining a wear condition, in particular for predicting a remaining service life and/or a remaining operational life of at least one running strand (2; 2a, 18) of a device (1; 1a) which uses at least one running strand for its intended use, in which a position of strand segments (12; 12a, 23) of at least one running strand (2; 2a, 18) is ascertained during the operation of the device. Expediently, for each strand segment (12; 12a, 23) of at least one running strand (2; 2a, 18) when changing a load position Li of a load (6, 9; 6a) moved with the device (1; 1a) to a subsequent load position Lᵢ₊₁ at least one wear parameter is ascertained, from which the wear condition of at least one running strand (2; 2a, 18) is ascertained. Advantageously, a dynamic method is designed that takes into account the actual changes in load positions and thus enables a more precise ascertainment of the wear condition than is possible with methods known from the prior art.

The invention relates to a method for ascertaining a wear condition, in particular for predicting a remaining service life and/or a remaining operational life, of at least one running strand of a device which uses at least one running strand for its intended use, in which a position of strand segments of at least one running strand is ascertained during the operation of the device. The invention further relates to a device which has at least one running strand and a strand guiding means for at least one running strand and a sensor device for ascertaining a movement speed of the strand guiding means and/or a force acting on at least one strand. The invention also relates to a computer program product.

A running strand is a strand of a device which, when the device is used as intended, i.e. during its operation, is moved over a strand guiding means and thereby redirected, i.e. bent (see, for example, the German VDI guideline 2358 from 2012, notably section 5.1).

Such a device can be, for example, a lifting device or a locking device.

A lifting device is a device that is designed to move a load, in particular to raise or lower it. A lifting device can be a derrick such as a rotating tower crane, a harbor crane, a crawler crane, a luffing crane or an elevator, which can be designed as a passenger or freight elevator. It is understood that an elevator is only intended to move an elevator cab with or against a direction of action of gravity.

A running strand of a lifting device can be designed as a lifting strand or as an adjusting strand. The lifting strand can be used to move a load to be moved with the lifting device in or against a direction of action of the force of gravity, i.e. upwards or downwards, while the adjusting strand can be used to move adjustable, for example, pivotable lifting device elements such as jibs or so-called trolleys of cranes.

A locking device can be provided for opening a weir or a lock, in which the locking gate, also known as a clough, can be opened or closed, for example, by running chains. In particular, the locking gates can be moved horizontally, i.e. from a closed position to an open position or vice versa.

Strand guiding means are all means that guide the running strand in its movement and can be designed, for example, as sheaves such as rope sheaves, as pulleys such as rope pulleys, or as drums such as rope drums, onto which the running strand can be wound or off of which the running strand can be unwound.

Running strands can be designed as ropes, for example as wire ropes, fiber ropes, hybrid ropes, load tapes, load belts or load chains.

While running ropes such as wire ropes are used in particular for load cranes, load tapes or load belts are used, for example, for passenger or freight elevators.

Load chains are used, for example, in locking devices such as locks or weirs.

A strand segment is a section of at least one running strand with a length of at least 0.20 mm, preferably 0.50 to 5.00 mm. The inventor has found that a strand segment length of between 0.5 mm and 5.00 mm leads to the formation of a particularly accurate method in which, even with very long strands such as crane ropes,

surprisingly, there is only an insignificant additional computational effort, in particular if the method is designed as a computer-implemented method or simulation method. The sum of the length of all strand segments corresponds to a total length L of at least one running strand. The strand segments can also be several centimeters or several meters long.

Although the strand segments can be of different sizes, i.e. in particular of different lengths, the strand segments are preferably of the same size.

According to section 11 of the German VDI guideline 2358 from 2012, the total operational life of a strand is defined as “the time between when [the strand] is put in place and when one of the replacement criteria specified in the standards is reached”, while the total service life is defined as “the time between when [the strand] is put in place and when it breaks”. The total operational life is therefore the time during which the strand can be used reliably in the device, while the total service life is the time during which the strand can be used until it fails. It is understood that the total operational life is less than the total service life. A strand is referred to as in a replacement state when it has to be replaced due to wear in order to be able to continue operating the device, in particular a lifting device, safely (see, for example, ISO 4309 from August 2021).

The wear condition of a running strand within the meaning of the present invention can be, for example, its remaining operational life or its remaining service life. The remaining operational life and the remaining service life are calculated from the total operational life or the total service life specified for the running strand minus the usage- and load-dependent usage life that has already taken place.

In particular, the remaining operational life or the remaining service life can be specified as the number of remaining bending cycles of at least one running strand, on the basis of which it can be estimated how long the device can still be operated for, i.e. how many bending cycles can still take place until the total operational life or the total service life is reached.

A wear parameter can be the so-called bending cycle number known to the specialist. A curvature of at least one running strand by a strand guiding means causes a bending cycle, where-by a full bending cycle is a curvature from straight to bent to straight. A full bending cycle has

the bending cycle number 1.0.

A full bending cycle is experienced, for example, by a strand segment that is guided completely over a strand guiding means and is thereby bent twice, once from straight to bent when passing into the strand guiding means and a second time from bent to straight when leaving the strand guiding means.

A half bending cycle would be a single curvature from straight to bent or vice versa and would have a bending cycle number of 0.5.

Various types of bending cycles and their associated bending cycle numbers are described in the VDI guideline 2358 from 2012, for example on page 12 (section abbreviations).

Further wear parameters may be geometric parameters of the strand guiding means of the device, geometric parameters of at least one running strand such as its diameter or its design and/or a force acting on at least one strand, in particular a force acting in a longitudinal direction of at least one strand. Parameters that are relevant to wear and that can be easily ascertained by appropriate sensors such as weight or force sensors are used.

The design of a wire rope is ascertained, for example, by the number of strands and the number of strand layers (see ISO 4309 from August 2021). The design of a rope can also be referred to as a rope class (see e.g. DIN EN 12385-2 from 2008).

In addition, the groove size of a strand guiding means such as a strand guiding sheave can have an influence on strand wear if, for example, the strand is squeezed into the groove under tensile stress and is thereby under stress from lateral forces.

A diameter of the strand guiding means, by which a radius of curvature of the strand is ascertained when it is guided, is also relevant to wear.

It is conceivable that further wear parameters can be ascertained from the aforementioned wear parameters, for example, so-called bending cycle factors, which in turn depend on a strand bending length and/or a strand diameter.

The wear condition of the running strand can be ascertained on the basis of the wear parameters. For this purpose, there are prediction models, which are known for example from “Drahtseile—Bemessung, Betrieb, Sicherheit” (Klaus Freyrer, 3rd edition, Vieweg Verlag, ISBN 978-3-642-54295-4) or ISO 4309 (version: August 2021).

It is understood that the transfer of the prediction models to other types of ropes such as fiber ropes or hybrid ropes does not pose any problems for the specialist. Further prediction models are known in particular from “Zur Abschätzung der Lebensdauer von laufenden hoch-modularen Faserseilen” (Gregor Novak, Dissertation; Berichte aus dem Institut für Fördertechnik und Logistik, University of Stuttgart; November 2017) and from “Beitrag zur Unter-suchung des Lebensdauerverhaltens von Drahtseilen unter einer kombinierten Bean-spruchung aus Zug, Biegung und Torsion” (Tobias Weber, Dissertation; Berichte aus dem Institut für Fördertechnik und Logistik, University of Stuttgart; September 2013).

In addition to the definitions mentioned in the present application, reference is also made to the German VDI guideline 2358 from 2012, which is known to the specialist, as well as the standards cited therein, in particular ISO 4309.

A method and a device for ascertaining the replacement state of a fiber rope of a rotating tower crane in operation based on a change in the torsional stiffness of the fiber rope are known from DE 10 2013 017 110 A1. The basis of this method is the knowledge that the torsional stiffness of a fiber rope increases as the load figure increases. If a limit value is exceeded, a crane operator is given an acoustic or optical signal that the rope is due for replacement.

A device and a method for ascertaining the remaining service life of a fiber rope of a crane are known from DE 10 2013 014 265 A1. The parameter used to ascertain a rope's service life is a change in the bending stiffness of the fiber rope.

CN 103112781 A describes a method for the real-time ascertainment of a service life of a wire rope used in a crane based on a bending cycle distribution. Since each rope is only allowed to reach a certain number of bending loads before it is due for replacement, it is possible to ascertain in real time when the rope should be replaced. The disadvantage of this method is that the replacement state is ascertained solely on the basis of the bending cycle distribution, and other factors relevant to wear, in particular the weight of a moving load, are not taken into account. As a result, the method known from CN 103112781 A is very inaccurate. Also, CN 103112781 A does not take into account any interactions of a lifting strand with an adjusting strand.

DE 20 2011 001 846 U1 describes a method and a device for ascertaining the remaining service life of a fiber rope used in a crane. For this purpose, several parameters are used, in particular a so-called indicator profile, which can be embedded in the core of a strand or between fiber strands and which shows changes under load faster than the fiber ropes or fiber strands of the fiber rope. A detection device detects several magnetic, mechanical, optical and/or electronic rope characteristics, for example a covered rope path or the elongation of a rope section. An evaluation unit uses the rope characteristics to ascertain whether the fiber rope is due for replacement.

A method for ascertaining the wear on a winch rope of a snow groomer as well as for ascertaining a remaining operational life is known from DE 10 2011 080 466 A1. For this purpose, sensors detect various rope parameters, partly indirectly based on the position of a winch arm or a GPS position of the snow groomer.

Methods for ascertaining the wear condition of a wire rope are also known from DE 10 2004 063 709 B3 , US 2017/045493 A1 and JP 2020 040801 A.

It is also known from the prior art that, assuming certain load cases, the service life of a running rope can be estimated. Since in practice these assumptions are often prone to error, this kind of service life prediction, known as a static service life prediction, is inaccurate. Disadvantageously, frequent visual inspections are required.

The object of the invention is to provide a method of the type mentioned at the outset, by means of which a more precise ascertainment of the wear condition of a running strand of a device, which may be a lifting or a locking device, is possible, in particular in real time.

According to the invention, the object is achieved in that for each strand segment of at least one running strand, when a load position Lᵢ of a load moved by the device changes to a sub-sequent load position Lᵢ₊₁, at least one wear parameter is ascertained, from which the wear condition of at least one running strand is ascertained.

The load positions Lᵢ and Lᵢ₊₁ relate to a spatial arrangement of a load that is moved by the device from an initial position Lᵢ to a subsequent position Lᵢ₊₁.

If, for example, a lifting load is lifted by 10 m by a crane, this would be a change from an initial load position L₁, in which the lifting load is attached to a crane hook, to a load position L₂, in which the lifting load is raised by 10 m.

If lock gates of a lock are opened, this would be a change from a load position L₁, i.e. a closed position of the lock gates, to a load position L₂, i.e. an open position of the lock gates. For example, a horizontal movement of the lock gates would cause wear on a running strand through which the opening is carried out.

A first strand segment may be the strand segment through which the running strand is connected to a strand guiding means such as a rope drum, while a last strand segment may be the one that is connected, for example, to a load-lifting device such as a crane hook.

Expediently, at least one wear parameter is ascertained for each of the strand segments, in particular a number of bending cycles and/or a longitudinal force acting on the strand segment,

and a remaining service life and/or a remaining operational life is ascertained for each strand segment.

For running strands such as wire ropes for lifting devices, for example cranes, relevant wear parameters are, for example, a number of bending cycles, a longitudinal force acting on the rope, which is ascertained by a weight of a lifting load, and a diameter of strand guiding means, over which the running strand is guided.

By ascertaining a remaining service life and/or a remaining operational life for each strand segment, a particularly accurate prediction method is preferably created. For this purpose, the inventor has recognized that the strand segment or strand segments with the shortest remaining service life or remaining operational life correspond to the remaining operational life or remaining service life of the running strand. Only those strand segments must be subjected to an inspection such as a visual inspection, so that an inspection effort for a running strand is substantially reduced by the method according to the invention.

It is conceivable that a correction factor is calculated, by which an operational life and/or remaining service life expressed as a number of remaining bending cycles is reduced. Such a correction factor, which is less than 1 and greater than zero, can be calculated, for example, when a running strand is used with loads of different weights, or if some strand segments of a running strand have the same number of bending cycles as other strand segments, but have been guided over a strand guiding means with a smaller diameter than the one over which the other strand segments were guided. The higher the load or the smaller a strand guiding means, the higher the wear of a running strand or the affected strand segments and the shorter the remaining operational life or the remaining service life of the running strand.

With the method according to the invention, a wear condition can be ascertained for each change of a load position Lᵢ. Advantageously, a dynamic method is developed which takes into account the actual changes of load positions and thus enables a more precise ascertainment of the wear condition than is possible with methods known from the prior art.

Expediently, the position of each strand segment of at least one running strand is ascertained based on a position of a strand guiding means guiding at least one running strand and/or a movement speed of a strand guiding means guiding at least one running strand when the load position Lᵢ changes to the subsequent load position Lᵢ₊₁.

For this purpose, a position of the strand segments at times tⱼ can be ascertained by a sensor device with which the device is provided, and which comprises a sensor for ascertaining a movement speed of a strand guiding means, when the load position Lᵢ changes to the sub-sequent load position Lᵢ₊₁ according to defined time increments Δt, by using known geometric parameters of the strand guiding means and/or a rotational speed of the strand guiding means.

For example, in the case of a rotating tower crane, a lifting path by which a load is lifted is ascertained by a number of revolutions of a rope drum onto which a lifting rope carrying a lifting load is wound during lifting, and its diameter and other geometric parameters. This allows the position of each strand segment to be ascertained at any point in time tⱼ when the load-lifting position Lᵢ changes to the subsequent load-lifting position Lᵢ₊₁.

In one embodiment of the invention, adjacent strand segments of at least one running strand with the same number of bending cycles are combined to form a strand section forming a strand segment group, and load classes are formed within each strand segment group, whereby strand segments of the same wear stress, in particular strand segments guided over strand guiding means of the same size and/or under stress from the same longitudinal force, form a load class.

Advantageously, the formation of strand segment groups creates an efficient method, since it is not necessary to calculate a separate wear condition for each strand segment, but only for strand segment groups. For instance, if a current strand has 100 strand segments that can be combined into three strand segment groups, the wear condition must be ascertained three times, rather than 100 times.

In particular, the strand segments can be directly adjacent.

In the case of a running strand of a lifting device, for example, a longitudinal force acting on the strand or its strand segments, a number of bending cycles and a diameter of a strand guiding means are those relevant wear parameters that are relevant for ascertaining a remaining service life and/or remaining operational life. The inclusion of other relevant wear parameters such as a groove depth of a strand guiding means is conceivable.

Strand segments of the same wear stress are in particular those of a strand segment group that have been stressed with the same longitudinal force and/or have been guided over strand guiding means of the same size, in particular those with the same diameter and the same groove depth. It is conceivable that other wear parameters such as a strand guiding means groove depth can be used.

By forming strand segment groups, a computer-aided computational effort for ascertaining the wear condition can be significantly reduced.

By forming load classes within a strand segment group, a particularly accurate method is created, since it is not only a number of bending cycles that are taken into account to ascertain the wear condition, but also other relevant wear parameters, which act as corrections, by which a remaining service life or remaining operational life is reduced with the same number of bending cycles.

If, for example, a strand segment is guided over a strand guiding means with a diameter d₁, its wear is higher with the same number of bending cycles than when guided over a strand guiding means with a diameter d₂, where d₁<d₂.

In particular, a wear condition of such strand segments, which experience fewer bending cycles than other strand segments, but are under more heavy stress than these, since the bending

cycle is carried out by strand guiding means which, for example, have a particularly small diameter, can be ascertained by a method according to the invention, so that a wear condition of the entire running strand can be ascertained particularly precisely.

It is advantageous and user-friendly if a remaining service life or a remaining operational life is ascertained in a number of remaining bending cycles and displayed to a user. It is conceivable that the remaining service life or the remaining operational life is indicated to a user of a lifting device as the number of remaining load cycles.

By forming strand segment groups with load classes, it is also ensured that even with large load position changes, an exact ascertainment of the remaining service life and remaining operational life of the running strand is possible, since intermediate steps can also be recorded.

In one embodiment of the invention, a remaining service life and/or a remaining operational life is ascertained for each load class, and a remaining service life and/or a remaining operational life of the strand segment group is ascertained from this.

Advantageously, it can be ascertained within a strand segment group which load class significantly determines the remaining service life and/or a remaining operational life of the strand segment group. Advantageously, a correction of a remaining service life and/or a remaining operational life based solely on ascertaining a number of bending cycles is possible. A particularly accurate method is created in which the wear condition can be displayed to a user in an understandable manner.

In a further embodiment of the invention, the wear condition of at least one running strand in the load position Lᵢ₊₁ is ascertained starting from the load position Lᵢ.

To ascertain the wear condition of at least one running strand, only a change compared to an existing wear condition is considered. Advantageously, a particularly efficient method is developed.

For example, a wear condition in the load position Lᵢ can be a remaining number of bending cycles until the so-called replacement state of the running strand is reached. A remaining number of bending cycles until the replacement state is reached in the load position Lᵢ₊₁ would be the number of bending cycles in the load position Lᵢ less a number of bending cycles which is ascertained by wear when changing the load position Lᵢ to the subsequent load position Lᵢ₊₁.

In a further embodiment of the invention, the wear condition of at least one running strand is ascertained on the basis of a damage hypothesis, for which a movement of at least one running strand and a force acting on at least one running strand are taken into account when changing the load position Lᵢ to the subsequent load position Lᵢ₊₁.

A damage hypothesis can be an equation into which values of ascertained wear parameters are input and which outputs a remaining service life or a remaining operational life as a function of the wear parameters. Examples of damage hypotheses can be found, for example, in the aforementioned book by Klaus Feyrer, “Drahtseile—Bemessung, Betrieb, Sicherheit”, in particular in Chapter 3.4—Allgemeine Berechnungsmethode für Seiltriebe (General calculation method for rope drives).

Depending on the application, more complex damage hypotheses can be used, which additionally take into account the forces actually acting on the running strand for each strand segment. These forces can be frictional forces between the strand and a strand guiding means, or lateral forces that occur due to strand guidance through the strand guiding means. It is conceivable that by adding geometric parameters of the strand guiding means such as their diameter or a groove depth and/or width, correction factors can be ascertained which significantly determine the wear condition, that is, in particular, reduce a remaining operational life and/or a remaining service life.

Expediently, the wear condition of at least one running strand is ascertained through the continuous operation of the device.

Advantageously, a person involved in the maintenance or inspection of at least one running strand can concentrate on those strand sections that have been particularly worn. Even more advantageously, a real-time method for ascertaining a wear condition of at least one running strand is developed.

In contrast to static methods known from the prior art, where assumptions about possible load positions must be made in order to ascertain a remaining operational life or remaining service life of a running strand, continuous real-time ascertainment of the wear condition advantageously enables a more precise prediction of a service life or operational life as well as the possibility of identifying those strand sections that are particularly worn. These can also be subjected to intensive visual inspection, for example.

In one embodiment of the invention, for each running strand of a lifting device which has several running strands, a wear condition of a lifting strand and/or an adjusting strand of the lifting device in the load position Lᵢ₊₁ is ascertained, preferably in such a way that inter-actions of several running strands are taken into account.

In a lifting device, a load position is a spatial arrangement of a lifting load. A running strand can be a lifting strand, while another running strand can be an adjusting strand of the lifting device.

Currently known methods for ascertaining a wear condition of at least one running strand usually only concern the wear condition of the load strand without taking into account the wear that the lifting strand experiences due to a movement of the adjusting strand. The adjusting strand is usually not considered in the methods known from the prior art and is only subjected to a regular, time-consuming visual inspection during which the lifting device cannot be used.

Interactions of strands occur, for example, when a first movement of an adjusting strand causes a strand guiding means, which guides a lifting strand, to change its spatial position in such a way that the lifting strand, for example by a second movement, which can be a vertical lifting load movement, experiences more bending cycles than without taking into account the first, horizontal movement of the strand guiding means.

A wear condition of the lifting strand in the load position Lᵢ₊₁ can be ascertained by super-imposing wear conditions that can be ascertained independently of each other.

It is understood that more than two independent movements are conceivable.

Advantageously, a wear condition of the running strands of the lifting device can be ascertained particularly precisely, and therefore a 30 remaining service life and/or a remaining operational life, after which at least one strand must be replaced, can be ascertained particularly reliably.

The method according to the invention is particularly advantageous for those lifting devices which, for example, have several driven strand drums such as rope drums, for example rotating tower cranes, luffing, mobile, crawler or container loading cranes.

In a further embodiment of the invention, the method is designed as a computer-implemented method.

For this purpose, the computer can have a database in which positions of strand guiding means, the changeable positions of the strand segments, as well as geometric parameters of the running strand used and the strand guiding means are stored.

When the load position Lᵢ changes to the subsequent load position Lᵢ₊₁, a position change of each strand segment can be ascertained during the position change using the data stored in the database. A change in the spatial position of a strand guiding means can also be taken into account.

If, for example, a wear-relevant movement of one of the strand segments, for example over a strand guiding means, is detected during this position change, an entry is made for this strand segment in the database in a strand segment dataset. For example, for winding a strand segment onto a drum, the strand segment dataset can be supplemented by a bending cycle number of 0.5.

For the strand segments or for strand sections which have strand segments with the same wear parameters, a wear condition is calculated and an output signal is generated and emitted. For this purpose, various wear parameters as well as calculation methods for ascertaining the wear condition, for example damage hypotheses, can be stored in the database using the wear parameters.

It is understood that wear-relevant geometric parameters of one of the strand guiding means which a strand segment has passed when the load position Lᵢ changes to the sub-sequent load position Lᵢ₊₁ can supplement the strand segment dataset.

It is also understood that strand segment groups and/or load classes can be formed and stored in the database, wherein a parameter of the strand segment dataset is its belonging to a strand segment group and/or a load class.

The output signal can be a remaining number of bending cycles until the strand is due for replacement or a strand failure or a remaining number of load cycles.

Expediently, at least one wear parameter and/or the wear condition of at least one running strand is displayed graphically over a length of the running strand on a display screen, preferably during or after each change of the load position Lᵢ to the subsequent load position Lᵢ₊₁. This graphic representation may be a diagram in which at least one wear parameter and/or the wear condition is displayed as a function of a strand position between 0 and a total length L of the running strand.

It is conceivable that a display takes place as a function of the strand segments, whereby a first strand segment begins at position 0 and a last strand segment ends at position L (total length of the strand).

Advantageously, real-time monitoring of the running strand is possible, in which further strand areas which are advantageously particularly heavily stressed are easily recognizable.

In one embodiment of the invention, a change in at least one wear parameter and/or the wear condition of at least one running strand during the change of the load position Lᵢ to the subsequent load position Lᵢ₊₁ is continuously displayed graphically over a length of the running strand on a display screen.

This graphic representation may be a diagram that changes after each time increment Δt in which at least one wear parameter and/or the wear condition is displayed as a function of a strand position between 0 and a total length L of the running strand. Δt is a time increment after which an ascertainment of the position of strand segments takes place during a change of the load position Lᵢ to Lᵢ₊₁.

Advantageously, wear can be tracked in real time during the change of a load position.

In a further embodiment of the invention, the method is designed as a simulation method in which a prediction of a wear condition of a running strand when changing a load position Lᵢ of a moving load into a subsequent load position Lᵢ₊₁ is carried out.

If a method according to the invention is designed as a simulation method, a designer of a lifting or locking device can simulate various load cases and ascertain a wear condition of a running strand of the lifting or locking device. Based on a simulation result, it is conceivable that a design of the lifting or locking device may be changed in such a way that, with the same load cases, a longer remaining operational life or a longer remaining service life of the running strand is achieved. For this purpose, for example, strand guiding means such as rope sheaves can be geometrically modified, or their spatial position within the lifting or locking device can be modified.

Advantageously, a method according to the invention designed as a simulation method enables a design of a lifting or locking device that is optimized for strand wear.

A device according to the invention, which is in particular a lifting device or a locking device, is characterized in that the device comprises at least one drive mechanism for moving at least one running strand and is configured to carry out a method according to the invention.

A drive mechanism is provided for moving at least one running strand and would be, for example, a drum drive in the case of a crane, i.e. a driven rope drum onto or off of which a running lifting rope can be wound and unwound.

It is not necessary for the device itself to have an evaluation system such as a computer. It is conceivable that only sensor data of the device may be collected and transmitted wirelessly to the evaluation system by a transmitting device, whereby the evaluation system is configured to ascertain the wear condition, which may be a remaining service life and/or a remaining operational life of at least one running strand.

Advantageously, sensor data from various operated devices can be stored and processed centrally. In particular, a database can be provided in which all

the sensor data is stored. It is conceivable that historical sensor data may be used to ascertain the wear condition of at least one running strand with new or previously unused prediction models or damage hypotheses. Advantageously, the method according to the invention can be adapted in the continuous operation of the device in such a way that an even more precise ascertainment of the wear condition is possible.

In one embodiment of the invention, the device has at least one adjusting strand and/or at least one lifting strand. Advantageously, ascertaining a wear condition of running strands is even possible for complex devices with many strands, for example for cranes such as rotating tower cranes, container loading cranes or other lifting devices.

A computer program product according to the invention is characterized in that it comprises commands which, when the program is executed by the computer, cause it to carry out a method according to the invention according to claim 7 or 11. By using a computer, a high degree of automation is possible. In addition, the ascertained wear parameters can be stored and retrieved at any time, for example to use with other, for example more accurate and computationally intensive models to ascertain a wear condition. Advantageously, a method is also

created by which it is possible to retrospectively ascertain the wear condition of at least one running strand, for which stored data can be used.

The invention is explained in more detail below with reference to execution examples and the accompanying drawings relating to the execution examples. The figures show:

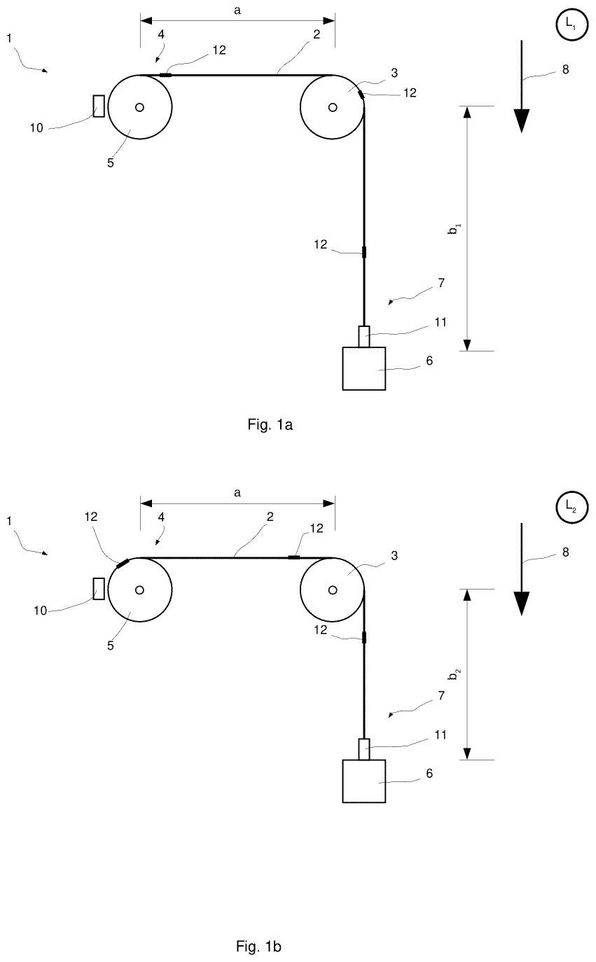

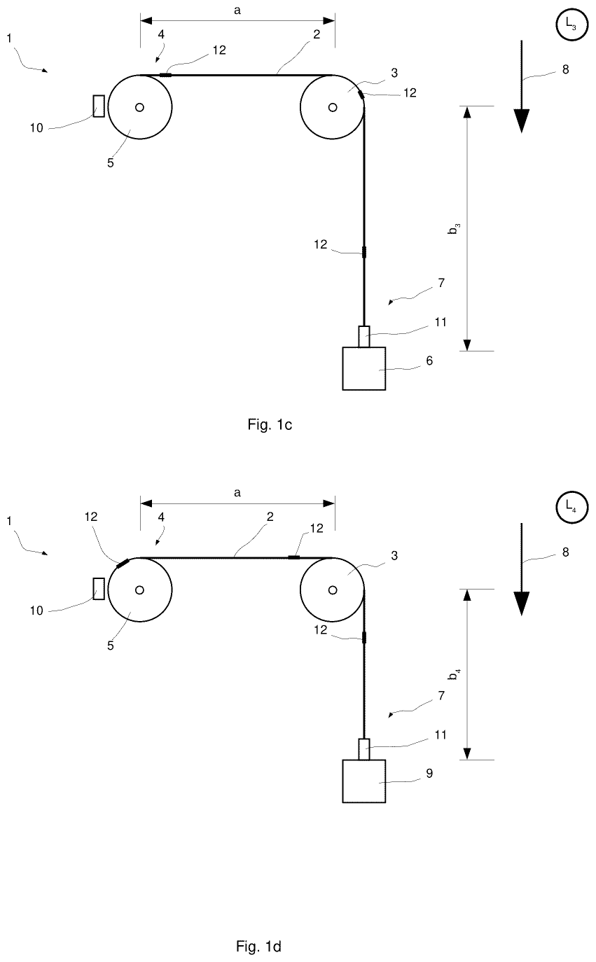

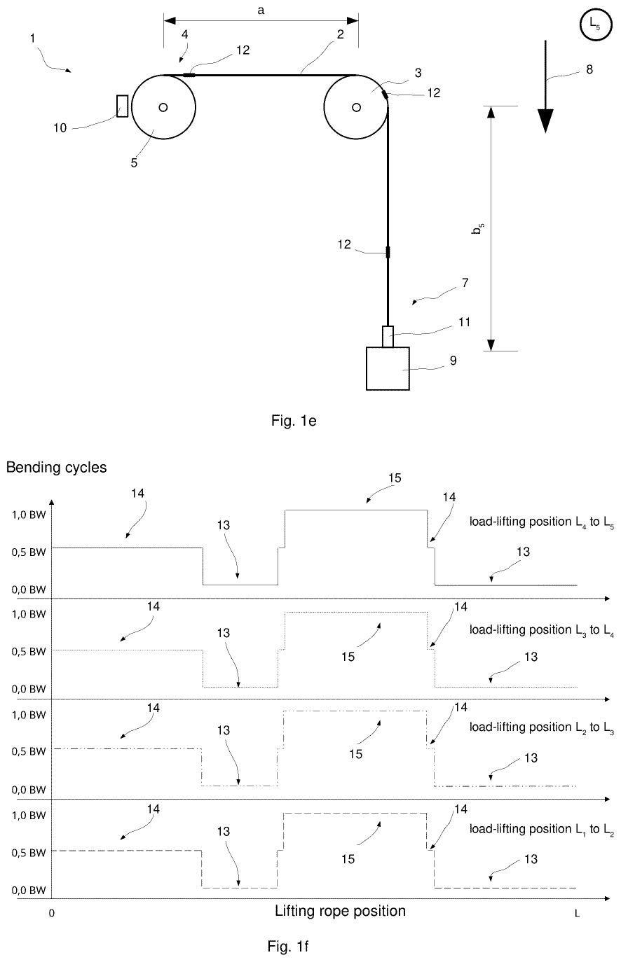

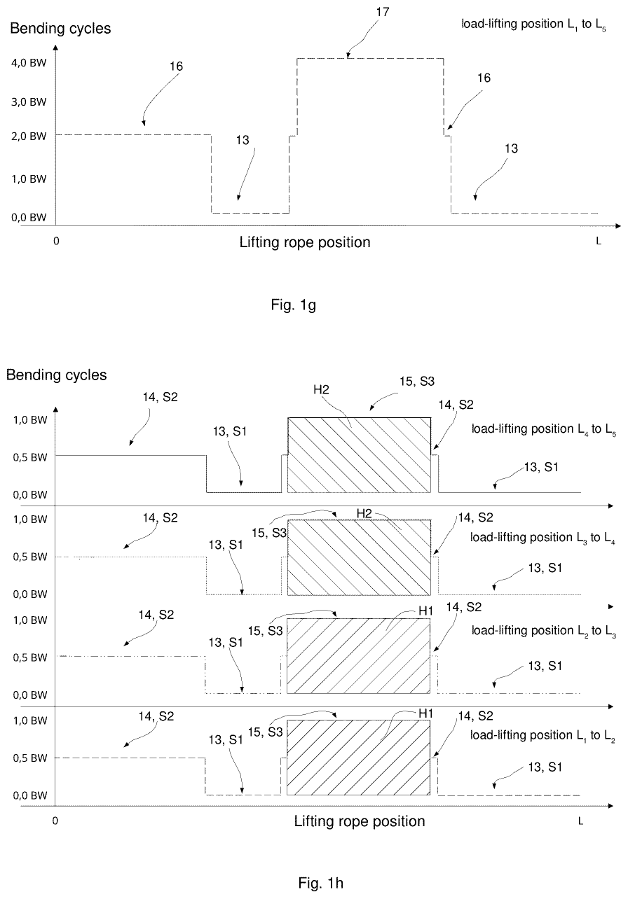

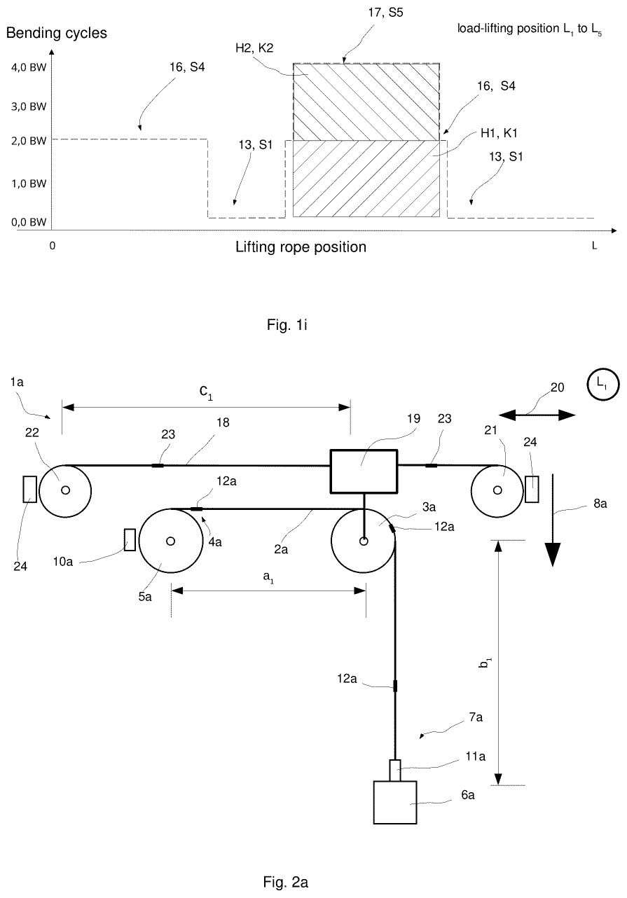

FIG. 1 A device according to the invention, which is designed as a lifting device, in five different load-lifting positions L₁ to L₅,

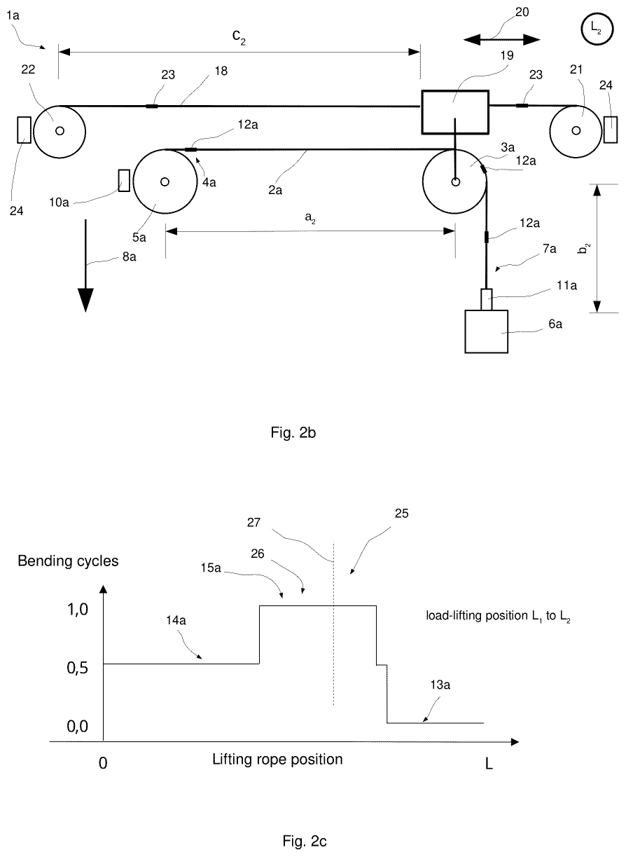

FIG. 2 A further device according to the invention, which is designed as a lifting device and which has a running adjusting rope, in two load-lifting positions L₁ and L₂,

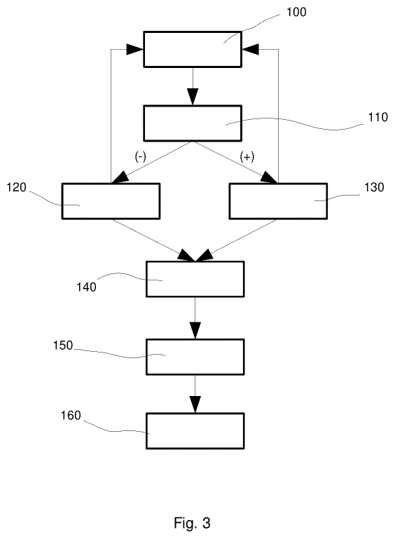

FIG. 3 Method steps of a method according to the invention for ascertaining a wear condition of at least one running strand.

An embodiment of the method according to the invention according to FIG. 3 as well as an ascertainment of a remaining service life and a remaining operational life is explained using execution examples shown in FIGS. 1 and 2, which show simple lifting devices.

A lifting device 1, shown schematically in FIG. 1 and designed as a crane, comprises a running lifting rope 2 with a total length L, which is redirected over a rotatable rope sheave 3, with a wrap-around angle of 90 degrees. This means that the lifting rope 2 is redirected 90 degrees by the rope sheave 3. In this execution example, the running lifting rope 2 is designed as a stranded wire rope.

At a first end 4, the lifting rope 2 can be wound onto and off of a driven rope drum 5 in order to raise or lower a lifting load 6, which is attached to a second end 7 of the rope 2.

In this execution example, the lifting load 6 is moved exclusively against or with the direction of action of gravity 8, i.e. upwards or downwards, from a load-lifting position L₁ shown in FIG. 1a to a load-lifting position L₂ shown in FIG. 1b and from the load-lifting position L₂ to a load-lifting position L₃ according to FIG. 1c, which corresponds to the load-lifting position L₁ in relation to a load-lifting position 6. A load-lifting position L₄ according to FIG. 1d corresponds to the load-lifting position L₂ in relation to a further load-lifting position 9, while a load-lifting position L₅corresponds to the load-lifting positions L₃ and L₁ in relation to a load-lifting position 9. The load-lifting positions L₁ to L₃ do not differ from the load-lifting positions L₄ and L₅. Only the lifting load 9 in the load-lifting positions L₄ and L₅ is twice as large as the lifting load 6 in the load-lifting positions L₁ to L₃.

With each movement from the initial load-lifting position Lᵢ to the subsequent load-lifting position Lᵢ₊₁, the lifting rope 2 is subjected to wear stress, in particular due to deflections, i.e. curvatures when winding onto or unwinding off of the rope drum 5 or when deflecting by the rope sheave 3. This means that any change in the load-lifting position Lᵢ to Lᵢ₊₁ causes wear, which can change a wear condition that may be a remaining operational life.

A distance from the rope drum 5 to the rope sheave 3 is denoted by a, while a variable distance from the rope sheave 3 to the lifting load 6 is denoted by bi, where i stands for a load-lifting position Li, and i=1, 2, 3, 4, 5. In this execution example, the distance a is constant, i.e. the rotatable rope sheave 3 and the driven rope drum 5 are in a fixed position relative to each other.

The lifting device also has a sensor device with two sensors 10, 11, of which a motion sensor 10 is set up to detect a movement speed of the driven rope drum 5 and a weight sensor 11 to ascertain a mass of the lifting load 6, 9. A wireless transmission device (not shown) transmits sensor data from the sensors 10, 11 to an evaluation system (not shown in FIG. 1), which is designed as a computer and is configured to carry out a method according to the invention for ascertaining a wear condition of at least one running strand.

The lifting rope 2 with the total length L is divided into lifting rope segments 12 of equal size, i.e. equal length, whereby the total length L is a distance from the lifting rope ends. For reasons of clarity, only individual lifting rope segments 12 are shown in FIG. 1.

In the load-lifting position L₁, the position of each lifting rope segment 12 as well as the fixed position of each wire rope guiding means, i.e. the driven rope drum 5 and the rotatable rope sheave 3, are known, and stored in a database of the evaluation system configured as a computer.

If the lifting load is moved from the load-lifting starting position L₁ shown in FIG. 1a to the load-lifting position L₂ shown in FIG. 1b, i.e. raised by a distance Δb=b₁−b₂, a rotation of the driven rope drum 5 is required, in which some of the lifting rope segments 12 are wound onto the rope drum 5 and are thereby bent. Other lifting rope segments experience a complete bending cycle when the lifting load 6 is lifted by the rope sheave 3, while other lifting rope segments 12 in the area of the lifting load 6 do not experience any bending cycle. Those lifting rope segments 12 which are guided into the load-lifting position L₁ by the rotatable rope sheave 3, i.e. are bent, leave the guidance of the rope sheave 3 in the direction of the rope drum 5 by the rotation of the rope drum 5 for lifting the lifting load 6.

The motion sensor 10 of the lifting device 1, which detects a rotational frequency and a rotational speed of the driven rope drum 5 when lifting the lifting load 6 and transmits it to the evaluation system, a position change of the lifting rope segments 12 is ascertained by the evaluation system on the basis of the position of the rope drum 5 and the rope sheave 3 in this execution example as well as their geometric parameters, which can ascertain the positions of the strand segments 12, whereby it is possible to ascertain overall which lifting rope segments 12 were subjected to bending cycles.

For this purpose, each lifting rope segment 12 is assigned a so-called bending cycle number, i.e. a number of bending cycles that have taken place. Those lifting rope segments that have the same number of bending cycles form a lifting rope section.

FIG. 1f shows the number of bending cycles (BW) for each load-lifting position L₁ to L₅ over a length of the lifting rope 2 from 0 to the total length L, while FIG. 1g shows the total number of bending cycles after reaching the load-lifting position L₅ over a length of the lifting rope 2 from 0 to the total length L.

In this execution example, as shown in FIGS. 1f and 1g, there are a total of four lifting rope sections 13-17 with the number of bending cycles (BW) 0, 0.5, 1, 2 and 4.

In FIG. 1f, for example, a plateau 14 comprises, when the load-lifting position L₁ changes to the subsequent load-lifting position L₂, those lifting rope segments which were straight in the load-lifting position L₁ and were wound onto the driven rope drum 5 by lifting the lifting load 6, while another plateau 13 comprises those lifting rope segments which were not bent when the load-lifting position was changed, i.e. neither wound onto the rope drum 5 nor guided over the rope sheave 3. Those lifting rope segments which were guided completely over the rope sheave 3, i.e. bent from straight to bent and bent back to straight, were subjected to a complete (1.0) bending cycle when the load-lifting position L₁ changed to the subsequent load-lifting position and form the lifting rope section 15.

By adding the number of bending cycles shown in FIG. 1f for each load-lifting position Lᵢ, the diagram shown in FIG. 1g was generated, which shows a total number of bending cycles in the load-lifting position L₅.

It can be clearly seen that the lifting rope segments of lifting rope section 17, which can be read off on the horizontal axis, have experienced the highest bending cycle load and significantly determine the remaining operational life and the remaining service life of the lifting rope.

In order to be able to reliably ascertain the correct number of bending cycles of the lifting rope segments 12, their positions are continuously ascertained when the running lifting rope 2 moves from the load-lifting position Lᵢ to the load-lifting position Lᵢ₊₁. As soon as a change in the state of one of the lifting rope segments 12 is detected, i.e. as soon as a lifting rope segment 12 is redirected, for example by the rotatable rope sheave 3 or the driven rope drum 6, half a bending cycle is stored for the respective lifting rope segment in a lifting rope segment dataset in the database of the evaluation system.

After each lifting process, i.e. a completed change of a load-lifting position, or already during this process, a number of bending cycles is ascertained for each lifting rope section 13-17. The lifting rope section that has the highest number of bending cycles is relevant for ascertaining the remaining service life of the lifting rope or the remaining operational life of the lifting rope on the basis of calculation formulae known from the prior art (see, for example, Klaus Feyrer, “Drahtseile—Bemessung, Betrieb, Sicherheit,” 3rd Edition, Vieweg Verlag, ISBN 978-3-642-54295-4, specifically Chapter 3.4.4), since the lifting rope segments of this lifting rope section were subjected to the highest stress.

Advantageously, the method according to the invention enables the identification of lifting rope segments that have experienced the greatest wear. A visual inspection of the lifting rope 2 over its entire length L can be carried out, but it is possible to concentrate on the most heavily stressed lifting rope sections 13-17.

In this execution example, the remaining service life is, for example, 125,000 bending cycles in the lifting rope section 17 and 155,000 in the lifting rope section 16.

Overall, the remaining service life of the lifting rope 2 is ascertained by the section of the lifting rope that has the shortest remaining operational life. In this execution example, this is the lifting rope section 17. Overall, the lifting rope 2 thus has a remaining operational life of 125,000 bending cycles.

A more precise ascertainment of a remaining service life or a remaining operational life is possible if a weight of the lifting load 6, 9 is taken into account as a further wear parameter in addition to the number of bending cycles. This is shown in FIGS. 1h and 1i for the load positions shown in FIGS. 1a to 1e.

In this execution example, a weight of the lifting load 9 (load-lifting positions L₄ and L₅) is twice as large as a weight of the lifting load 6 (load-lifting positions L₁ to L₃). The weight can be ascertained by the weight sensor 11.

Each lifting rope section 13-17 forms a lifting rope segment group S1 to S5, whereby S1 corresponds to lifting rope section 13, S2 corresponds to lifting rope section 14, etc. For reasons of clarity, FIGS. 1h and 1i show the acting lifting load 6 schematically as a hatched rectangle H1 and the acting lifting load 9 schematically as a hatched rectangle H2 in the diagram that shows the number of bending cycles as a function of the lifting rope position only for the lifting rope segment group S3.

Within a lifting rope segment group S1 to S5, those lifting rope segments 12 which have been guided over rope sheaves of the same size and/or under stress from the same longitudinal force, which in this execution example is a lifting load 6, 9, are combined to form a load class K1 for the lifting load 6 and a further load class K2 for the lifting load 9. In this execution example, the lifting rope segments 12 of the lifting rope section 17 form two load classes K1 and K2. This is shown in FIG. 1i by way of example for the lifting rope segment group S5.

For each load class K1, K2, a remaining service life and/or a remaining operational life is ascertained and from this a remaining service life

and/or a remaining operational life of the lifting rope segment group S1 to S5 is ascertained. A remaining lifting rope service life and/or a remaining lifting rope operational life is ascertained on the basis of the lifting rope segment group S1 to S5 which has the shortest remaining lifting rope segment service life and/or remaining lifting rope segment operational life.

In this execution example, the remaining operational life of the

load class K1 is 110,000 bending cycles and for the load class K2 it is 89,000 bending cycles. The remaining operational life of the lifting rope segment group S5 is ascertained by the smallest value and is therefore 89,000 bending cycles. By including a lifting load 6, 9 by forming load classes, the higher accuracy compared to a method in which only one bending cycle number is used for ascertaining wear stress is shown.

While the remaining operational life of the rope 2 according to FIG. 1g is 125,000 bending cycles, the remaining operational life of the rope according to FIG. 1i is 89,000 bending cycles, i.e. a correction of 36,000 bending cycles took place. A corresponding correction factor is thus 0.712.

Examples of wear stress calculation formulae or so-called damage hypotheses for lifting ropes subjected to different loads are known to the rope technology specialist from, for example, Horst Czichos—“Tribologie-Handbuch—Tribometrie, Tribomaterialien, Tribotechnik”—3rd edition—2010-ISBN 978-8-8348-0017-6, or Oliver Berner—Dissertation—“Lebensdauer von Stahlseilen beim kombinierten Lauf über Treib- und Ablenkschei-ben unterschiedlicher Rillenform”, University of Stuttgart, June 2011, ISO 4309 (as of August 2021) or Klaus Feyrer, “Drahtseile—Bemessung, Betrieb, Sicherheit”, 3rd edition, Vieweg Verlag, ISBN 978-3-642-54295-4, FIG. 3.88 as well as the description thereof.

The damage hypotheses take into account, for example, wear on the lifting rope due to guidance over rope sheaves, which lead to rope pressure, or due to a permanent reduction in the diameter of the lifting rope, which is caused by tensile loads. Damage hypotheses can be used, for example, for each lifting rope segment, each lifting rope segment group or each load class.

By combining a service life prediction based on a bending cycle stress and a damage hypothesis that takes into account, for example, a tensile force acting on the lifting rope and/or geometric parameters of rope guiding means, a lifting rope's remaining service life or remaining operational life can be very accurately ascertained, since other relevant, load-dependent wear parameters are taken into account. For example, by adding the damage hypothesis, it is conceivable that a lifting rope section can be identified that has fewer bending cycles than other rope sections, but is more heavily worn due to a higher load caused by a lifting load.

Reference is now made to FIG. 2, where the same or equivalent parts are designated with the same reference number as in FIG. 1 and the letter a is attached to the respective reference number.

A lifting device 1a, shown schematically in FIG. 2 and designed as a crane, differs from the lifting device shown in FIGS. 1a to 1e in that a two-part adjusting rope 18 is provided, by means of which a so-called trolley 19 can move a rotatable rope sheave 3a, over which a lifting rope 2a is guided, in a direction of movement 20 perpendicular to the effective direction of gravity. In this execution example, the trolley 19 is designed as a cart that can be moved along a lifting device guide, not shown in FIG. 2.

The two-part adjusting rope 18, both parts of which are connected to the trolley 19 with ends facing the trolley, can be wound onto and off of driven trolley rope drums 21 or 22 to move the trolley 19.

The adjusting rope 18 is divided into adjusting rope segments 23 of equal size.

A number of revolutions of the driven trolley rope drums 21 and 22 and a rotational speed can be detected by motion sensors 24.

The lifting rope 2a can be wound onto and off a driven rope drum 5a and is guided over the rotatable rope sheave 3a.

A variable distance of the rope drum 5a from the rope sheave 3a is denoted by aᵢ, while a variable distance of the trolley rope drum 22 from the trolley 19 is denoted by cᵢ. A variable distance of a lifting load 6a from the rope sheave 3a is denoted by bᵢ. The index i stands for the respective load-lifting position in this execution example and can be 1 or 2.

For reasons of clarity and simplification, the distance of the trolley rope drum 21 from the trolley 19 is not shown.

In order to explain the method according to the invention for the lifting device 1a according to the invention with three rope drums (5a, 21, 22), the load-lifting position L₁ shown in FIG. 2a and the load-lifting position L₂ shown in FIG. 2b are considered. This lifting movement is a com-bination of a lifting component 25, which is effected by a horizontal movement of the trolley 19 in the direction of an arrow 20, and a lifting component 26, which is effected by a movement of the lifting rope 2a of the lifting device 1a, which is wound onto a rope drum 5a.

A number of bending cycles over a lifting rope length between 0 and a total length L for both lifting components 25, 26 is shown in FIG. 2c. To better separate the two movements, the two lifting components 25, 26 in FIG. 2 c are separated from one another by a vertical line 27. The number of bending cycles shown in FIG. 2c can be used to ascertain the remaining operational life of the running lifting rope 2a.

Although not shown in FIG. 2c, it is conceivable that wear on the adjusting rope 18 may be ascertained or that a weight of the lifting load 6a as well as geometric parameters of the rope sheave 3a and/or the rope drum 5a may be included as wear parameters in the ascertainment of the wear condition. This can be done in the same way as the method described for FIGS. 1h and 1i.

Reference is now made to FIG. 3, where the same or equivalent parts are designated with the same reference number as in FIGS. 1 and 2 and the letter c is attached to the respective reference number.

In a method according to the invention, in an initial method step 100 at the beginning of a change of a load position Lᵢ to a subsequent load position Lᵢ₊₁ at specified times tⱼ and for discrete time increments Δt, sensor signals from sensors such as movement or weight sensors of the device are detected.

From these sensor signals, a position of strand segments of a running strand of the device is ascertained for each time tⱼ. For this purpose, a computer is preferably provided as an evaluation device, on which a piece of evaluation software is run, in which the positions of strand guiding means at time tⱼ as well as their geometric parameters and a course of the running strand between the strand guiding means are stored in a database. Each strand segment has its own strand segment dataset, in which wear-relevant parameters of the strand segment as well as its position at any time tⱼ are stored.

In a next method step 110, for each time tⱼ, based on a position change of each strand segment and in knowledge of the positions of the strand guiding means, it will be ascertained whether a strand segment is experiencing a change in a wear condition. This is the case, for example, when a deflection is caused by a strand guiding means, i.e. a bending of the strand segment.

If no (−), only the new position of the strand segment is entered in the database, i.e. in the strand segment dataset (method step 120).

If yes (+), the new position of the strand segment at the point in time tⱼ and its new state are entered in the strand segment dataset (method step 130).

Values for a change in the wear condition of the strand segments are known to the evaluation software. For example, the value for a full bending cycle is 1.0.

After method step 120 or 130, method step 100 is repeated.

Thereafter, strand segments with the same number of bending cycles are combined by the evaluation software to form a strand section (method step 140).

Based on the strand section that has the highest number of bending cycles, the remaining service life or remaining operational life (method step 150) of the running strand is ascertained using known formulae, which can be output to a user, preferably as the remaining number of bending cycles until the replacement state (=remaining operational life), or as a graphic representation (method step 160).

The method steps 100 to 150 or to 160 are carried out until the subsequent load position Lᵢ₊₁, for example the load-lifting position designated as L₂ in FIG. 1, is reached.

It is conceivable that the method steps 100 to 120 or 130 are carried out until the subsequent load position Lᵢ₊₁, for example the load-lifting position designated in FIG. 1 as L₂, is reached, and only then do the method steps from 140 follow.

It is understood that the weight of a lifted load can also be taken into account as a wear parameter. For this purpose, the weight of the lifting load could be taken into account in method steps 120 and 130 and stored in the strand segment dataset of the strand segment. In addition, wear-relevant geometric parameters of strand guiding means such as their diameter or their groove depth for each strand segment that this strand guiding means passes when the load position changes from Lᵢ to Lᵢ₊₁ can be stored in the strand segment dataset.

In this case, in method step 140, strand segments of the same number of bending cycles would be combined by the evaluation software to form a strand section, each strand section forming a strand segment group, within which additional load classes of the same wear stress can be formed. The same wear stress can, for example, be the same acting longitudinal force, which can correspond to a lifting load, and/or a guide over strand guiding means of the same size. For each load class, a remaining service life and/or a remaining operational life is ascertained in order to ascertain a remaining service life and/or a remaining operational life of the strand segment group. By comparing the ascertained remaining service life and/or remaining operational life of all the strand segment groups, a remaining service life and/or remaining operational life of the running strand can be ascertained (method step 150), since this corresponds to the smallest remaining service life and/or remaining operational life of all strand segment groups. Advantageously, a particularly accurate and fast method is created.

It is understood that at any point in time tⱼ a notably graphical output of a wear parameter and/or a wear condition of the running strand over its strand length, i.e. a strand position, is conceivable.

It is also understood that the method according to the invention can be configured as a simulation method in which changes in a load position of a lifting device in a computer can be ascertained virtually on the basis of virtual sensor data, as can the resulting wear on a lifting rope of the lifting device.

The method according to the invention is therefore not dependent on real sensor data.

1. Method for ascertaining a wear condition, in particular for predicting a remaining service life and/or a remaining operational life of at least one running strand of a device which uses at least one running strand for its intended use, in which a position of strand segments of at least one running strand is ascertained during the operation of the device, wherein
for each strand segment of at least one running strand when changing a load position Lᵢ of a load moved with the device to a sub-sequent load position Lᵢ₊₁ at least one wear parameter is ascertained, from which the wear condition of at least one running strand is ascertained.

2. Method according to claim 1, wherein
for each of the strand segments at least one wear parameter, in particular a number of bending cycles and/or a longitudinal force acting on the strand segment, is ascertained, and a remaining service life and/or a remaining operational life is ascertained for each strand segment.

3. Method according to claim 1, wherein
adjacent strand segments of at least one running strand with the same number of bending cycles are combined to form a strand section forming a strand segment group and within each strand segment group load classes are formed, whereby strand segments of the same wear stress, in particular strand segments guided over strand guiding means of the same size and/or under stress from the same longitudinal force, form a load class.

4. Method according to claim 3, wherein
a load class remaining service life and/or a load class remaining operational life is ascertained for each load class and a remaining service life and/or a remaining operational life of the strand segment group is ascertained from this.

5. Method according to claim 4, wherein
the remaining service life and/or the remaining operational life of the running strand is ascertained on the basis of a remaining service life and/or a remaining operational life of the strand segment group with the shortest remaining service life and/or the shortest remaining operational life.

6. Method according to claim 1, wherein
the wear condition of at least one running strand is ascertained on the basis of a damage hypothesis, for which a movement of at least one running strand and a force acting on at least one running strand when changing the load position Lᵢ to the subsequent load position Lᵢ₊₁ are taken into account.

7. Method according to claim 1, wherein
for each running strand of a lifting device with several running stands, a wear condition of a lifting strand and/or an adjusting strand of the lifting device in the load position Lᵢ₊₁ is ascertained, preferably in such a way that interactions of several running strands are taken into account.

8. Method according to claim 1, wherein
the method is designed as a computer-implemented method.

9. Method according to claim 1, wherein
at least one wear parameter and/or the wear condition of at least one running strand is displayed graphically over a length of the running strand on a display screen, preferably during or after each change of the load position Lᵢ to the subsequent load position Lᵢ₊₁.

10. Method according to claim 1, that wherein
a change in at least one wear parameter and/or the wear condition of at least one running strand during the change of the load position Lᵢ to the subsequent load position Lᵢ₊₁ is continuously displayed graphically over a length of the running strand on a display screen.

11. Method according to claim 1,
wherein
the method is designed as a simulation method in which a prediction of a wear condition of a running strand during or after the change of the load position Lᵢ of a moving load into the subsequent load position Lᵢ₊₁ takes place.

12. Device, in particular lifting device or locking device, comprising at least one running strand a strand guiding means for at least one running strand and a sensor device comprising at least one sensor for ascertaining a movement speed of the strand guiding means and/or a force acting on at least one strand, wherein
the device comprises at least one drive mechanism for moving at least one running strand and for carrying out the method according of claim 1.

13. Device according to claim 12, wherein
the device has at least one adjusting strand and/or at least one lifting strand.

14. Computer program product comprising commands which, when the program is executed by a computer, cause it to carry out the method according to claim 7.
